(19) United States
(12) Patent Application Publication
(10) Pub. No.: US 2009/0009551 A1
(43) Pub. Date: Jan. 8, 2009

(54) Liquid Ejecting Apparatus and Method of Ejecting Liquid

(75) Inventor: Toru TAKAHASHI, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/166,158

(22) Filed: Jul. 1, 2008

(30) Foreign Application Priority Data
Jul. 5, 2007 (JP) 2007-177616

(51) Int. Cl. B41J 29/38

(52) U.S. Cl. 347/14

(57) ABSTRACT

A liquid ejecting apparatus includes a head including a nozzle array in which nozzles for ejecting liquid droplets on a medium are aligned, a transport mechanism that transports the medium in a transport direction, a moving mechanism that moves the head in a moving direction that is a direction for intersecting the transport direction, a position determining mechanism that can position the head in a first position in which the direction of the nozzle array is a predetermined direction with respect to the transport direction and a second position in which the direction of the nozzle array is a direction different from the predetermined direction, and a controller that ejects liquid droplets on the medium with the head moving in the moving direction by using the moving mechanism in a case where the head is positioned in the first position, and transports the medium in the transport direction and ejects liquid droplets by using the head without moving the head in a case where the head is positioned in the second position.

### BACKGROUND

1. Technical Field

The present invention relates to a liquid ejecting apparatus and a method of ejecting liquid.

2. Related Art

There are liquid ejecting apparatuses that form an image on a medium by ejecting liquid droplets. Among the liquid ejecting apparatuses, there are apparatuses that fix a head such that a direction for intersecting the transport direction of the medium is the direction of a nozzle array and eject ink droplets with the medium transporting (a line method). In addition, in the liquid ejecting apparatuses, there are apparatuses that eject ink droplets with the head moving in a direction for intersecting the transport direction of the medium by disposing the head such that the transport direction of the medium and the direction of the nozzle array are identical (a serial method).

JP-A-2007-68202 is an example of related art.

When the width of the medium is smaller than that of the head, ink droplets can be ejected on the entire surface of the medium at high speed by using the above-described line method. On the other hand, when the width of the medium is larger than that of the head, ink droplets can be ejected on the entire surface of the medium by using the above-described serial method while intermittently transporting the medium. Accordingly, it is convenient if a head positioned in a predetermined angle with respect to the medium can be selectively used based on the situation such as the size of the medium.

### SUMMARY

An advantage of some aspects of the invention is that it provides an apparatus and a method in which ink droplets are ejected by selectively using a head positioned in a predetermined angle with respect to the medium based on the situation.

According to a major aspect of the present invention, there is provided a liquid ejecting apparatus including: a head including a nozzle array in which nozzles for ejecting liquid droplets on a medium are aligned; a transport mechanism that transports the medium in a transport direction; a moving mechanism that moves the head in a moving direction that is a direction for intersecting the transport direction; a position determining mechanism that can position the head in a first position in which the direction of the nozzle array is a predetermined direction with respect to the transport direction and a second position in which the direction of the nozzle array is a direction different from the predetermined direction; and a controller that ejects liquid droplets on the medium with the head moving in the moving direction by using the moving mechanism in a case where the head is positioned in the first position, and transports the medium in the transport direction and ejects liquid droplets by using the head without moving the head in a case where the head is positioned in the second position.

Other features of the invention will become apparent with reference to descriptions below and the accompanying drawings.

### BRIEF DESCRIPTION OF THE DRAWINGS

The invention will be described with reference to the accompanying drawings, wherein like numbers reference like elements.

FIG. 1 is a block diagram showing the whole configuration of a print system according to an embodiment of the invention.

FIG. 2A is a perspective view showing the internal structure of a printer according to an embodiment of the invention.

FIG. 2B is a cross-section view of the printer.

FIG. 3 is a diagram showing the configuration of a head unit according to an embodiment of the invention.

FIG. 4 is a diagram showing the configuration of a head according to an embodiment of the invention.

FIG. 5 is a diagram showing the structure for ejecting ink droplets from a nozzle according to an embodiment of the invention.

FIG. 6 is a diagram showing a driving signal according to an embodiment of the invention.

FIG. 7 is a diagram for describing a print operation according to an embodiment of the invention at a time when the head unit is in a first position.

FIG. 8 is a diagram for describing a print operation according to an embodiment of the invention at a time when the head unit is in a second position.

FIG. 9A is a diagram showing a case where a high-resolution print operation is performed by using a serial method according to an embodiment of the invention.

FIG. 9B is a diagram showing a distance between dots in the transport direction of the paper sheet which are formed by the nozzle array located in the first position of the modified example of the invention.

FIG. 10 is a diagram showing a case where a high-resolution print operation is performed by using a line method, according to an embodiment of the invention.

FIG. 11 is a diagram showing a case where two head units are fixed to the first and second positions according to an embodiment of the invention.

### DESCRIPTION OF EXEMPLARY EMBODIMENTS

At least the following aspects become apparent with reference to descriptions below and the accompanying drawings.

According to a first aspect of the invention, there is provided a liquid ejecting apparatus including: a head including a nozzle array in which nozzles for ejecting liquid droplets on a medium are aligned; a transport mechanism that transports the medium in a transport direction; a moving mechanism that moves the head in a moving direction that is a direction for intersecting the transport direction; a position determining mechanism that can position the head in a first position in which the direction of the nozzle array is a predetermined direction with respect to the transport direction and a second position in which the direction of the nozzle array is a direction different from the predetermined direction; and a controller that ejects liquid droplets on the medium with the head moving in the moving direction by using the moving mechanism in a case where the head is positioned in the first position, and transports the medium in the transport direction and ejects liquid droplets by using the head without moving the head in a case where the head is positioned in the second position.

Accordingly, the ink droplets can be ejected by selectively using a head positioned in a predetermined angle with respect to the medium based on the situation.

In the above-described liquid ejecting apparatus, it is preferable that the direction of the nozzle array for a case where the head is positioned in the first position is the transport direction. In addition, it is preferable that the direction of the nozzle array for a case where the head is positioned in the second position is a direction for intersecting the transport direction. In addition, it is preferable that the position determining mechanism rotates the head by using a part of the head as a fulcrum. In the above-described liquid ejecting apparatus, the position determining mechanism may include a first attachment part that can fixedly attach the head to the first position and a second attachment part that can fixedly attach the head to the second position.

In addition, it may be configured that one head is attached to the first attachment part and another head is attached to the second attachment part.

Accordingly, the ink droplets can be ejected by selectively using a head positioned in a predetermined angle with respect to the medium based on the situation.

According to a second aspect of the invention, there is provided a method of ejecting liquid droplets, the method including: ejecting liquid droplets on a medium with a head moving in a direction for intersecting a transport direction in a case where the head is positioned in a position in which the direction of a nozzle array is a predetermined direction with respect to the transport direction of the medium; and transporting the medium in the transport direction and ejecting liquid droplets by using the head without moving the head in a case where the head is positioned in a position in which the direction of the nozzle array is a direction different from the predetermined direction.

Accordingly, the ink droplets can be ejected by selectively using a head positioned in a predetermined angle with respect to the medium based on the situation.

### First Embodiment

### Overall Configuration

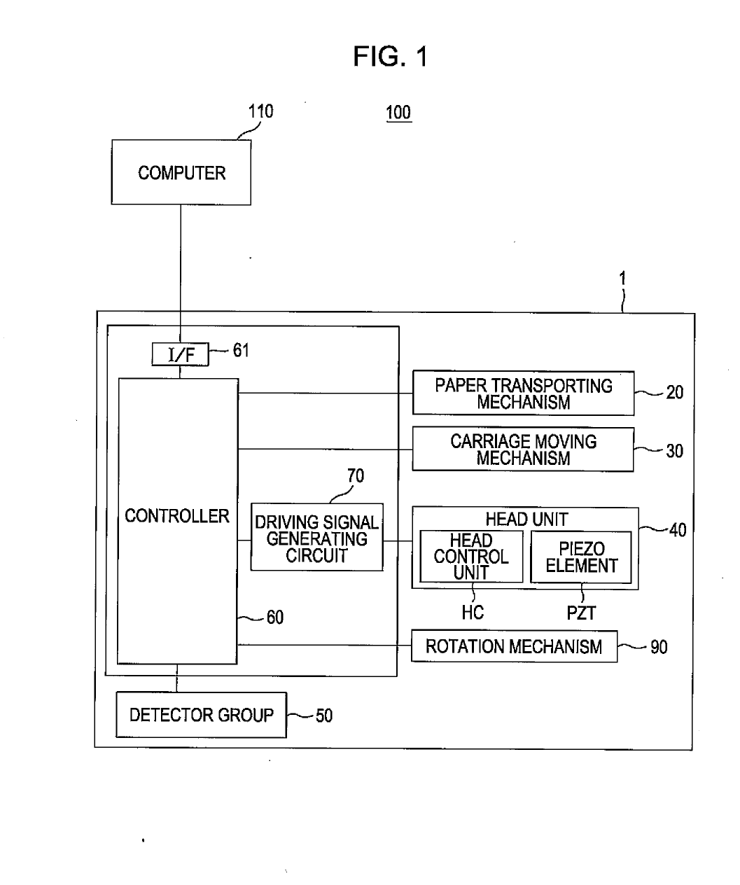

FIG. 1 is a block diagram showing the whole configuration of a print system. The print system 100 includes a printer 1 and a computer 110. Here, the printer 1 is an ink jet printer that prints an image on a medium such as a paper sheet, a cloth, or a film.

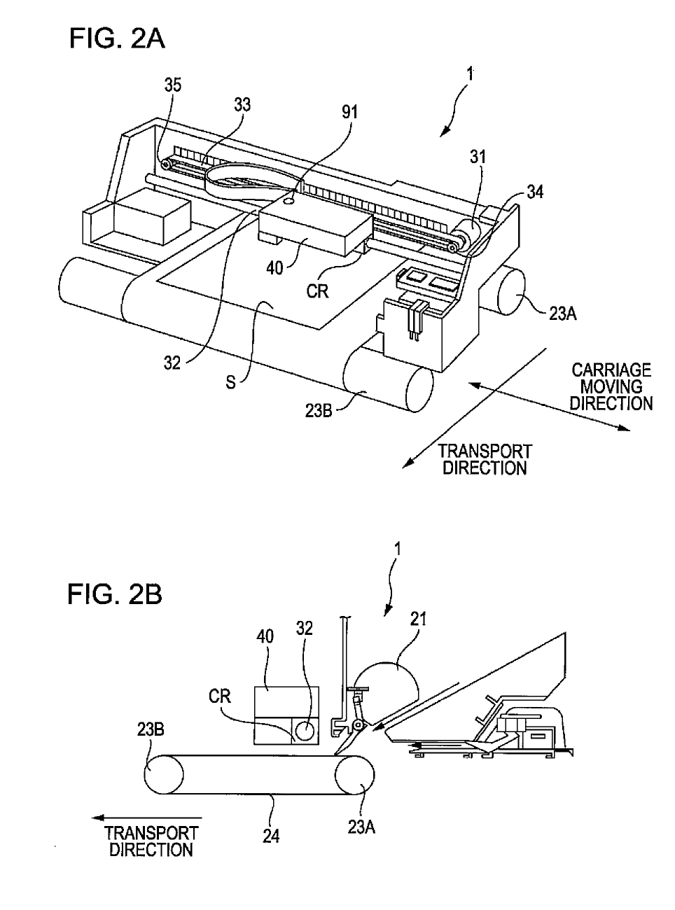

FIG. 2A is a perspective view showing the internal structure of the printer 1. FIG. 2B is a cross-section view of the printer 1. Hereinafter, the basic configuration of the printer 1 according to an embodiment of the invention will be described with reference to FIG. 1.

The printer 1 includes a paper transporting mechanism 20, a carriage moving mechanism 30, a head unit 40, a detector group 50, a controller 60, an interface 61, a driving signal generating circuit 70, and a rotation mechanism 90. The printer 1 receives print data from the computer 110. Then, the controller 60 of the printer 1 forms an image on a paper sheet S by controlling constituent units (the paper transporting mechanism 20, the carriage moving mechanism 30, the head unit 40, the driving signal generating circuit 70, and the rotation mechanism 90) of the printer 1.

The paper transporting mechanism 20 is for transporting a medium (for example, a paper sheet S or the like) in a predetermined direction (hereinafter, referred to as a transport direction). The paper transporting mechanism 20 includes a paper feed roller 21, a transport motor (not shown), an upstream transport roller 23A, a downstream transport roller 23B, and a belt 24. The paper feed roller 21 is a roller used for feeding the paper sheet S inserted into a paper insertion opening to inside of the printer 1. When the transport motor not shown in the figure is rotated, the upstream transport roller 23A and the downstream transport roller 23B are rotated so as to rotate the belt 24. The paper sheet S fed by the paper feed roller 21 is transported to a printable area (an area facing the head) by the belt 24. As the belt 24 transports the paper sheet S, the paper sheet S is moved in the transport direction with respect to the head unit 40. The paper sheet S passing through the printable area is discharged externally by the belt 24. The paper sheet S during a transport process is electrostatically absorbed or vacuum-absorbed to the belt 24.

The carriage moving mechanism 30 is used for moving a carriage CR to which the head unit 40 is attached in the carriage moving direction. The carriage moving direction is a direction for intersecting the above-described transport direction. The carriage moving mechanism 30 includes a carriage motor 31, a guide shaft 32, a timing belt 33, a driving pulley 34, and an idler pulley 35. The operation of the carriage motor 31 is controlled by the controller 60. To the rotation shaft of the carriage motor 31, the driving pulley 34 is attached. The driving pulley 34 is disposed on one end side of the carriage moving direction. On the other end side of the carriage moving direction which is located on a side opposite to the driving pulley 34, the idler pulley 35 is disposed. The timing belt 33 is a circle-shaped member of which one end part is fixed to the carriage CR and extends over the driving pulley 34 and the idler pulley 35. The guide shaft 32 supports the carriage CR to be movable. The guide shaft 32 is attached along the carriage moving direction. Accordingly, when the carriage motor 31 is operated, the carriage CR is moved in the carriage moving direction along the guide shaft 32. In accompaniment with the movement of the carriage, the head unit 40 moves in the carriage moving direction.

The head unit 40 is used for forming an image on a paper sheet S by ejecting ink droplets. The head unit 40 includes a plurality of nozzles, piezo elements PZT attached to the nozzles, and a head controller HC for controlling ejection of ink droplets. The configuration of the head unit 40 will be described later.

The state inside the printer 1 is monitored by the detector group 50. The detector group 50 outputs the result of detection to the controller 60. The controller 60 controls the constituent units based on the result of detection.

The detector group 50 includes a rotary encoder and the like. For example, the rotary encoder detects the amounts of rotation of the upstream transport roller 23A and rotation of the downstream transport roller 23B. The controller 60 is configured to be able to detect the amount of transport of the paper sheet S based on the result of detection of the rotary encoder.

The controller 60 is a control unit for controlling the printer 1. The controller 60 is connected to the interface 61 inside the printer 1 and is configured to be able to communicate with the computer 110. The controller 60 has a function for performing a calculation process that is used for controlling the overall operation of the printer. In addition, the controller includes a memory for storing a program and data. The controller controls the constituent units in accordance with the program stored in the memory.

The driving signal generating circuit 70 is a circuit that generates a driving signal COM applied to the piezo element PZT of the head unit 40 to be described later. The mechanism for ejecting ink droplets based on the driving signal COM will be described later

The rotation mechanism 90 is a mechanism for rotating the head unit 40 around the vertical direction of the surface of the paper sheet S. The rotation mechanism 90 will be described later.

### Configuration of Head Unit 40

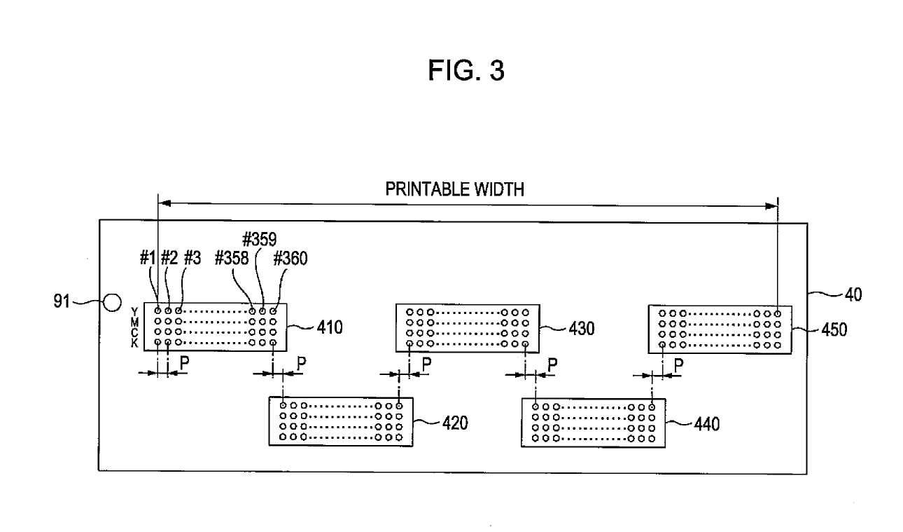

FIG. 3 is a diagram showing the configuration of the head unit 40. In the head unit 40, five nozzle groups (a first nozzle group 410 to a fifth nozzle group 450) are included. The diagram shows the first nozzle group 410 to the fifth nozzle group 450 of the head unit 40 viewed from the upper side of the printer 1. When viewed from the upper part of the printer, the nozzle groups are screened by other elements and cannot be seen. However, here, for easy understanding of position relationship among nozzles of the first nozzle group 410 to the fifth nozzle group 450, positions of the nozzles are drawn in solid lines.

Here, to each nozzle, as described later, a piezo element that can be transformed for ejecting ink droplets in accordance with application of a voltage is attached. By applying driving signals to be described later to the piezo elements, liquid droplets can be ejected.

In each nozzle group of the first nozzle group 410 to the fifth nozzle group 450, a yellow ink nozzle array Y, a magenta ink nozzle array M, a cyan ink nozzle array C, and a black ink nozzle array K are formed. Each nozzle array includes a plurality of nozzles that are ejection openings for ejecting ink. The plurality of nozzles of each nozzle array is aligned with a constant nozzle pitch. In addition, nozzles of the nozzle array of each color are aligned such that nozzles of a same nozzle number are in line with one another in a direction for intersecting the nozzle arrays.

Here, the nozzle pitch is 1/360 inch. In addition, the number of nozzles included in one nozzle array is 360. To the nozzles of each nozzle array, nozzle numbers are sequentially attached from the left side in the figure (#1 to #360). In addition, in the figure, the nozzle pitch in one nozzle array is denoted by “P”.

The nozzle pitch formed by the right-end nozzle (#360) of the first nozzle group 410 and the left-end nozzle (#1) of the second nozzle group 420 is 1/360 inch. In addition, the nozzle pitch formed by the right-end nozzle (#360) of the second nozzle group 420 and the left-end nozzle (#1) of the third nozzle group 430 is 1/360 inch. The nozzle pitch formed by the right-end nozzle (#360) of the third nozzle group 430 and the left-end nozzle (#1) of the fourth nozzle group 440 is 1/360 inch. In addition, the nozzle pitch formed by the right-end nozzle (#360) of the fourth nozzle group 440 and the left-end nozzle (#1) of the fifth nozzle group 450 is 1/360 inch.

By disposing as described above, an image of 5 inches (127 mm) in a direction for intersecting the relative moving direction of the paper sheet S can be formed by nozzle #1 of the first nozzle group 410 to nozzle #360 of the fifth nozzle group 450. In the figure, as a printable width, the width of nozzle #1 of the first nozzle group 410 to nozzle #360 of the fifth nozzle group 450 is shown.

In addition, in the left end of the head unit 40, a rotation shaft 91 of the rotation mechanism 90 for rotating the head unit 40 is attached. The head unit 40 is configured to be rotatable using the rotation shaft 91 as a fulcrum. The rotation mechanism 90 will be described later.

In addition, on the upper side of the head unit 40, an ink tank not shown in the figure is attached and is configured to supply ink to the head unit 40. In addition, in the head unit 40, the head controller HC, not shown in the figure, used for controlling the operation of the piezo element PZT of each nozzle of the head unit 40 is mounted. For receiving a signal from a control substrate of a main body of the printer 1, to the head controller HC, a flexible flat cable not shown in the figure is attached through the carriage CR. Accordingly, even when the head unit 40 is rotated by the rotation mechanism, to the head unit 40, needed ink is supplied and needed signals are transmitted.

Here, although one head unit is configured by five nozzle groups, the number of nozzle groups included in the head unit is not limited thereto. In addition, here, as a part for ejecting ink droplets, although the head unit 40 has been described as an example, the head unit includes a plurality of nozzles that are regularly arranged. Accordingly, the head unit has a same meaning as a head.

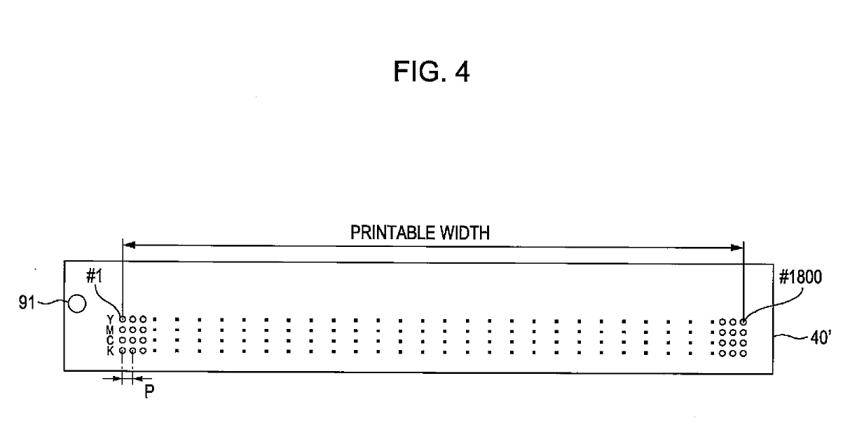

FIG. 4 is a diagram showing the configuration of a head 40′. As shown in the figure, nozzle arrays of each color are configured in one row with nozzles of nozzle #1 to nozzle #1800. Here, the nozzle pitch P is 1/360. In such a case, the printable width is a width of 5 inches from nozzle #1 to nozzle #1800. As described above, when the nozzle array of each color can be manufactured to be configured in one row, the head 40′ as shown in the figure may be used as the head unit.

In such a case, to the left end of the head 40′, the rotation shaft 91 of the rotation mechanism 90 for rotating the head 40′ is attached. In addition, an ink tank not shown in the figure and a flexible flat cable not shown in the figure are attached in the same manner as for the above-described head unit 40.

### Rotation Mechanism 90

The rotation mechanism 90 is a mechanism used for rotating the head unit 40 around the vertical direction of the surface of the paper sheet S. The rotation mechanism 90 includes the rotation shaft 91 attached to the head unit 40 and a head rotating motor (not shown) used for rotating the rotation shaft 91. By rotating the head rotating motor, the head unit 40 is configured to be rotated. The head rotating motor is rotated under control of the controller 60. Under the control of the controller 60, the head unit 40 can be moved to be positioned at a desired angle. The rotation mechanism 90 corresponds to a position determining mechanism.

### Structure for Ejecting Ink Droplets

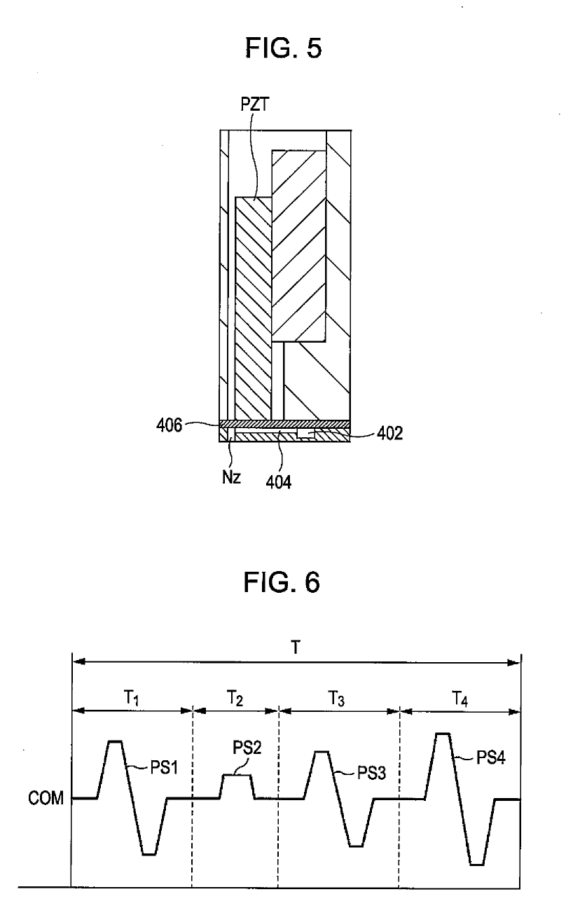

FIG. 5 is a diagram showing the structure for ejecting ink droplets from a nozzle. The structure shown in the figure is formed for each nozzle included in the head unit 40. In the figure, a nozzle Nz, a piezo element PZT, an ink supply path 402, a nozzle communication path 404, and an elastic plate 406 are shown.

To the ink supply path 402, ink is supplied from an ink tank not shown in the figure. Then, the ink is supplied to the nozzle communication path 404. To the piezo element PZT, a driving pulse to be described later is applied. When the driving pulse is applied, the piezo element PZT is expanded or contracted in accordance with a driving pulse signal and vibrates the elastic plate 406. Ink droplets of an amount corresponding to the amplitude of the driving pulse are configured to be ejected from the nozzle Nz.

FIG. 6 is a diagram showing a driving signal. As shown in the figure, the driving signal COM is repeatedly generated for every repetition period T. The driving signal COM includes a driving pulse PS1 in period T1, a driving pulse PS2 in period T2, a driving pulse PS3 in period T3, and a driving pulse PS4 in period T4. By applying the driving pulse PS1 to the piezo element PZT of the head, ink droplets for forming a middle dot are ejected. In addition, by applying the driving pulse PS2 to the piezo element PZT, a meniscus (a free surface of ink exposed from the nozzle part) is vibrated minutely. By applying the driving pulse PS3 to the piezo element PZT, ink droplets for forming a small dot are ejected. In addition, by applying the driving pulse PS4 to the piezo element PZT, ink droplets for forming a large dot are ejected.

The head controller HC selectively applies these driving pulses to each piezo element PZT under control of the controller 60 for forming dots in pixels of the paper sheet S.

### Print Operation

The printer 1 performs a print operation by changing an angle of the head unit 40 with respect to the direction of transport of a paper sheet in accordance with the size of the paper sheet. When the paper width of the paper sheet is larger than the printable width of the head unit 40, the head unit 40 is rotated and moved to a position (hereinafter, referred to as a first position) for matching the direction of the nozzle array to the transport direction. Then, the print operation is performed while the carriage CR is moved in the carriage moving direction. On the other hand, when the paper width of the paper sheet is equal to or smaller than the printable width of the head unit 40, the head unit 40 is rotated and moved to a position (hereinafter, referred to as a second position) for intersecting the transport direction with the direction of the nozzle array.

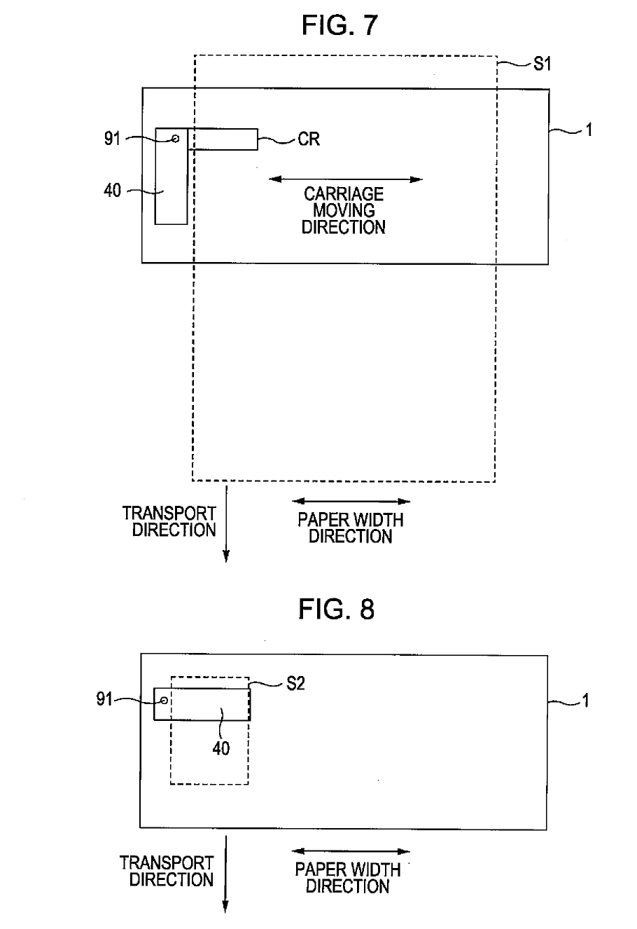

FIG. 7 is a diagram for describing a print operation at a time when the head unit 40 is in the first position. As shown in the figure, the head unit 40 is fixed to the carriage CR such that the nozzle array is aligned along a same direction as the transport direction of the paper sheet. In addition, in the figure, a paper sheet S1 is shown. Here, an operation for moving the carriage CR and an operation for transporting the paper sheet S1 are repeatedly performed. In other words, when ink droplets are ejected from the head unit 40 while the carriage CR moves in the carriage moving direction (that is, while the head unit 40 moves in the carriage moving direction), the paper sheet S1 is relatively stopped with respect to the printer 1. Then, when movement (one pass) of the carriage 40 is completed for one-time movement, the paper sheet S1 is transported by a predetermined amount in the transport direction. Then, while the carriage CR is moved again in the carriage moving direction, ink droplets are ejected from the head unit 40. As described above, by repeating the operation for moving the carriage CR and the operation for transporting the paper sheet S1, a print operation for the entire surface of the paper sheet S1 can be performed. Here, a print method described above is referred to as a serial method.

When the print operation is performed, the size of a paper sheet to be printed is selected through a printer driver by a user. At this moment, when the paper width of the selected paper sheet is larger than the printable width of the head unit 40, a print operation is performed by using the above-described serial method. Here, it is assumed that a paper sheet of size A4 (width 210 mm, length 297 mm) having the paper width larger than the printable width (127 mm) of the head unit 40 is selected

When the print operation is performed by using the serial method, the head unit 40 is rotated by the rotation mechanism 90 and precisely fixed to the first position with respect to the carriage CR such that the nozzle array of the head unit 40 is in a position (the first position) for matching the transport direction of the paper sheet S. When the head unit 40 is fixed to the first position, the paper sheet S1 is fed for starting the print operation. At this moment, the paper sheet S1, as described above, is transported in an intermittent manner. Then, when the paper sheet S is stopped with respect to the printer 1, ink droplets are ejected from the head unit 40 while the carriage CR moves in the carriage moving direction, and thereby the print operation is performed. By repeating the above-described operation, an image is formed on the entire surface of the paper sheet S1.

Accordingly, even when the paper width of the paper sheet S1 is larger than the printable width of the head unit 40, a print operation for the entire surface of the paper sheet can be performed. In addition, in the print operation using the serial method, by adjusting the moving speed of the head unit 40 in the carriage moving direction and the dot size, the resolution in the carriage moving direction can be increased. In addition, by performing intermittent transport of the paper sheet S in the transport direction with the amount of transport in units of a high resolution, the print operation can be performed by forming high-resolution dots in the transport direction of the paper sheet.

FIG. 8 is a diagram for describing a print operation at a time when the head unit 40 is in the second position. As shown in the figure, the head unit 40 is fixed such that the nozzle array is aligned in a direction for intersecting the transport direction of the paper sheet. Here, although the carriage CR is screened by the head unit 40 and cannot be seen, the head unit 40 is fixed to the carriage CR. In addition, in the figure, a paper sheet S2 is transported in the transport direction. Here, under the above-described disposition of the head unit 40, a method of printing the paper sheet S2 with the paper sheet S2 transported in the transport direction is referred to as a line method.

When the print operation is performed, the size of a paper sheet to be printed is selected through a printer driver by a user. At this moment, when the paper width of the selected paper sheet is smaller than the printable width of the head unit 40, a print operation is performed by using the above-described line method. Here, it is assumed that a postcard (width 100 mm, length 148 mm) having the paper width smaller than the printable width (127 mm) of the head unit 40 is selected.

As described above, when the postcard is selected as the paper sheet and the print operation is performed by using the line method, the head unit 40 is rotated by the rotation mechanism 90 such that the nozzle array of the head unit 40 is in a position (the second position) for intersecting the transport direction of the paper sheet S with the nozzle array of the head unit 40, and accordingly, the head unit is precisely fixed to the second position with respect to the carriage CR. When the head unit 40 is fixed to the second position, a paper sheet S is fed for starting the print operation. At this moment, while the paper sheet S is transported in a continuous manner, ink droplets are ejected from nozzles of the head unit 40. By landing the ejected ink droplets on the paper sheet S, an image is formed.

As described above, a print operation is performed by ejecting the ink droplets from the head unit 40 relatively fixed to the second position with respect to the printer 1 and transporting the paper sheet S, and thereby the print operation can be performed at high speed.

### Second Embodiment

In a second embodiment, a case where the first and second positions are configured different from those of the first embodiment will be described.

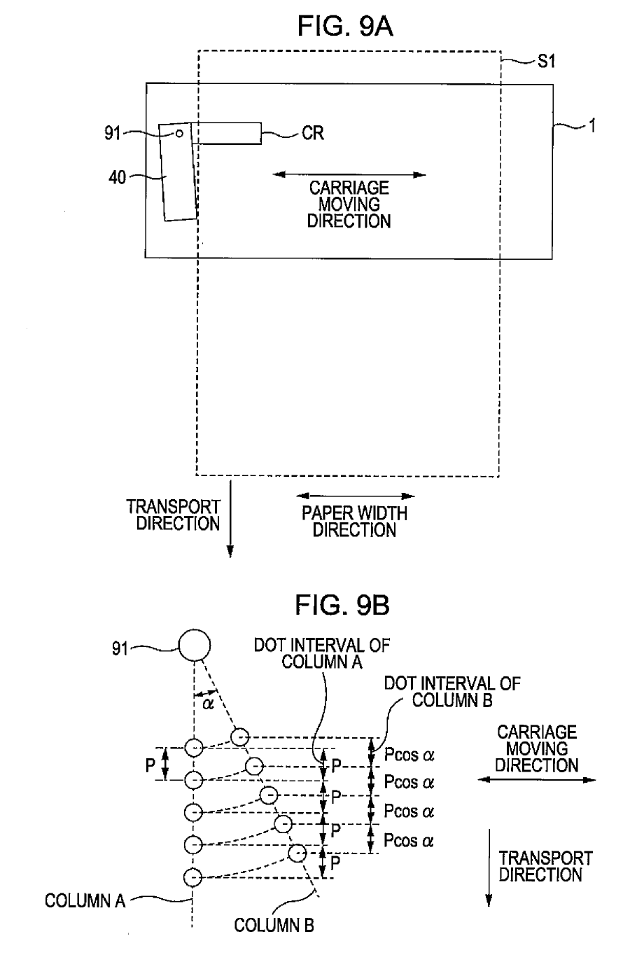

FIG. 9A is a diagram showing a case where a high-resolution print operation is performed by using the serial method. As shown in the figure, the head unit 40 is fixed to the first position of the modified example with respect to the carriage CR. In addition, in the figure, a paper sheet S1 is shown. Here, the first position is set as a position in which the nozzle array of the head unit 40 has a predetermined angle with respect to the transport direction of the paper sheet.

FIG. 9B is a diagram showing a distance between dots in the transport direction of the paper sheet which are formed by the nozzle array located in the first position of the modified example. In the figure, a nozzle array denoted by column A is disposed in a direction matching the transport direction. In addition, a nozzle array denoted by column B is disposed to be tilted in the counterclockwise direction with respect to the transport direction by an angle α from a rotation shaft 91 used as a fulcrum. In each column, a distance between nozzles is P.

A distance between dots in a case where ink droplets are ejected from nozzles of the nozzle array of column A is P that is the same as the distance between the nozzles. On the other hand, a distance between dots in a case where ink droplets are ejected from nozzles of the nozzle array of column B is “P·cos (α)”. In other words, by tilting the head unit with respect to the transport direction by a predetermined angle, the distance between the dots in the paper sheet in the transport direction can decrease. In other words, a distance between dots in a direction for intersecting the carriage moving direction can be decreased.

As described above, by tilting the head unit 40 by a predetermined angle with respect to the transport direction in the modified example as the first position, the distance between dots on the paper sheet S1 in the transport direction decreases, and thereby the resolution in the transport direction can be increased. In addition, here, positions of the nozzle are deviated from the carriage moving direction. Accordingly, ejection timings of ink droplets from the nozzles are adjusted so as to align the dots in the transport direction.

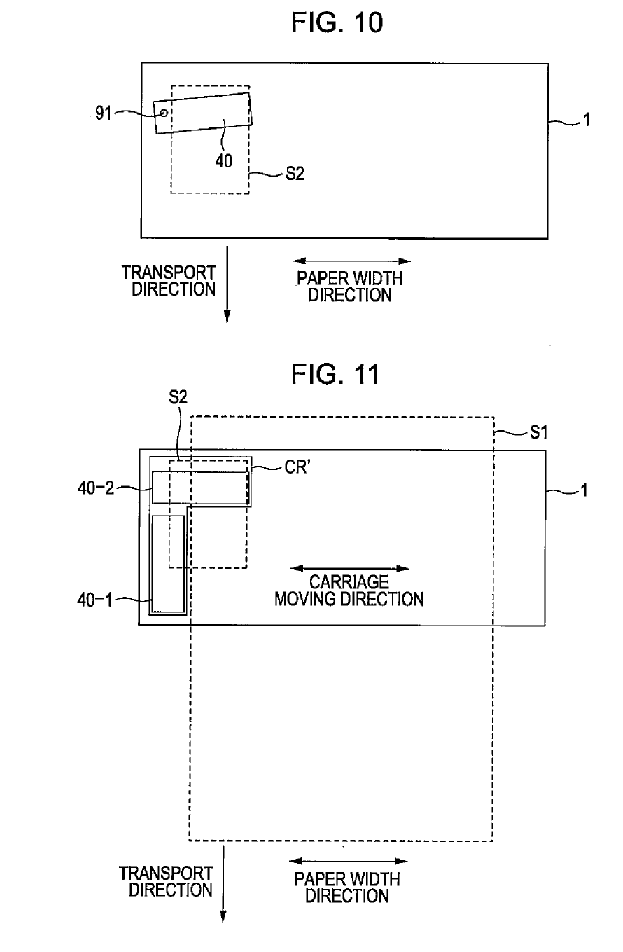

FIG. 10 is a diagram showing a case where a high-resolution print operation is performed by using the line method. In the figure, the head unit 40 located in a second position of the modified example is shown. In addition, a paper sheet S2 that is transported in the transport direction is shown.

Here, based on the same reason as that described above, the distance between the dots in the direction for intersecting a relative moving direction between the head unit 40 and the paper sheet S2 can be decreased. In other words, the distance between the dots in the paper width direction of the paper sheet S2 can be decreased. In addition, a print operation can be performed with an increased resolution in the paper width direction of the paper sheet S.

When a print operation is performed by using the line method, the relative position of the head unit 40 is fixed with respect to the printer 1, and thus it is difficult to perform a print operation with an increased resolution in the paper width direction of the paper sheet. However, as described above, by titling the angle of the head unit 40, a print operation with an increased resolution can be performed.

In addition, here, positions of the nozzle are deviated from the transport direction of the paper sheet. Accordingly, ejection timings of ink droplets from the nozzles are adjusted so as to align the dots in the transport direction.

### Third Embodiment

In the above described embodiments, a case where the head unit 40 can be rotated and moved to the first and second positions by the rotation mechanism 90 has been described. However, the head unit 40 may not be rotatable and movable. For example, the head unit 40 may be configured to be detachably attachable to the above-described first or second position with respect to the carriage CR′. In such a case, in the carriage CR′ and the head unit 40, an attachment mechanism that can be fixed to the first or second position is included. The attachment mechanism corresponds to a position determining mechanism.

The attachment mechanism may be, for example, a claw that is engaged with the carriage CR′ and the head unit 40 so as to fix one another. The attachment mechanism, for example, may fix the carriage CR′ and the head unit 40 with a screw.

Accordingly, the head unit 40 is precisely fixed to the first or second position of the carriage CR′, and thereby the positioning of the head unit 40 with respect to the paper sheet S can be performed with high precision. In addition, the print quality can be improved.

FIG. 11 is a diagram showing a case where two head units are fixed to the first position and the second position. Here two head units 40-1 and 40-2 are prepared in advance and are fixed to the first position (corresponding to a first attachment part) and the second position (corresponding to a second attachment part) of the carriage CR′.

As described above, when the head units 40-1 and 40-2 are attached to the first and second positions, any one between the above-described serial and line methods can be used for performing a print operation. In other words, while moving the carriage CR′ in the moving direction by the carriage moving mechanism, the controller 60 may eject ink droplets on a paper sheet S1 from the head unit 40-1 located in the first position. Alternatively, a paper sheet S2 may be transported in the transport direction, and the controller 60 may eject ink droplets from the head unit 40-2 located in the second position without moving the carriage CR′. In such a case, one print method may be selected by input for the printer driver.

In FIG. 11, the first position is set to a position in which the direction of the nozzle array matches the transport direction of the paper sheet. However, as the first position in the modified example, the first position may be a position in which the direction of the nozzle array has a predetermined angle with respect to the transport direction of the paper sheet. In addition, the second position may be a position in which the direction of the nozzle array has a predetermined angle with respect to the transport direction.

In addition, a third head unit may be additionally disposed and fixed to the carriage CR′.

### Other Embodiments

The above-described technology may be employed to various industrial apparatuses other than a print method in which a print operation is performed by ejecting ink on a paper sheet or the like. As major ones, there are a coloring apparatus (method) for forming a pattern in a cloth, a circuit board manufacturing apparatus (method) for forming a circuit pattern on a circuit board, a DNA chip manufacturing apparatus (method) for manufacturing a DNA chip by coating a chip with DNA-melt liquid, and a display manufacturing apparatus (method) of a display such as an organic EL display.

The above-described embodiments are not for purposes of limitation but for easy understanding of the present invention. The invention may be changed or modified without departing from the gist of the invention, and it is apparent that the equivalents belong to the invention. In particular, embodiments described below belong to the invention.

### Head

In the above-described embodiments, ink is ejected by using a piezoelectric element. However, the method of ejecting liquid is not limited thereto. For example, another method such as a method in which bubbles are generated inside the nozzle by using heat may be used.

In addition, the head has been described to be disposed in the carriage in the above-described embodiments. However, the head may be disposed in an ink cartridge that is detachably attachable to the carriage.

### Summing Up

The printer 1 as a liquid ejecting apparatus according to the above-described embodiments has a head unit 40 including a nozzle array in which nozzles for ejecting ink droplets on a paper sheet are aligned, a paper transporting mechanism 20 that transports the paper sheet in the transport direction, and a carriage moving mechanism 30 that moves the head unit 40 in a carriage moving direction that is a direction for intersecting the transport direction.

In addition, the printer 1 has a position determining mechanism (the rotation mechanism 90) that can position the head unit 40 in a first position in which the direction of the nozzle array is in a predetermined direction with respect to the transport direction and a second position in which the direction of the nozzle array is in a direction different from the predetermined direction.

In addition, the printer 1 has a controller 60 that ejects ink droplets on a paper sheet S1 with the head unit 40 moving in the carriage moving direction by using the carriage moving mechanism 30 in a case where the head unit 40 is positioned in the first position, and transports a paper sheet S2 in the transport direction and ejects ink droplets by using the head unit 40 without moving the head unit 40 in a case where the head unit 40 is positioned in the second position.

Accordingly, when the paper width is large, the head unit 40 is positioned in the first position and a print operation using the above-described serial method can be performed. On the other hand, when the paper width is small, the head unit 40 is positioned in the second position, and a print operation using the above-described line method can be performed.

When the head unit 40 is positioned in the first position, the direction of the nozzle array is the transport direction.

Accordingly, a position in which the direction of the nozzle array becomes the transport direction can be defined as the first position of the head unit 40.

When the head unit 40 is positioned in the second position, the direction of the nozzle array is a direction for intersecting the transport direction.

Accordingly, a position in which the direction of the nozzle array becomes the direction for intersecting the transport direction can be defined as the second position of the head unit 40.

The rotation mechanism 90 as a position determining mechanism rotates the head unit 40 using a part of the head unit 40 (here, the rotation shaft 91) as a fulcrum.

Accordingly, the head unit 40 is rotated by using the vertical direction of the surface of the paper sheet S as an axis, and thereby the head unit 40 can be moved to the first position or the second position.

The position determining mechanism may be an attachment mechanism having a first attachment part that can fixedly attach the head unit 40 to the first position and a second attachment part that can fixedly attach the head unit 40 to the second position.

Accordingly, the head unit 40 is precisely fixed to the carriage CR, and thereby the positioning precision of the head unit 40 can be improved. In addition, the print quality can be improved.

A configuration in which one head unit is attached to the first attachment part and another head unit is attached to the second attachment part may be used.

As described above, when the head units are attached to the first position and the second position, any one between the above-described serial and line methods can be used for performing a print operation. In other words, the controller 60 may eject ink droplets on a paper sheet S from the head unit located in the first position with the carriage CR′ moving in the moving direction by using the carriage moving mechanism, or may transport a paper sheet S in the transport direction and eject ink droplets from the head unit located in the second position without moving the head unit. In such a case, a print method to be used may be selected by input for the printer driver.

It is apparent that the following liquid ejecting method may be used. In the liquid ejecting method, ink droplets are ejected on a paper sheet S1 with the head unit 40 moving in a direction for intersecting the transport direction in a case where the head unit 40 is positioned in a position in which the direction of the nozzle array is in a predetermined direction with respect to the transport direction of the paper sheet S. In addition, in the liquid ejecting method, a paper sheet S2 is transported in the transport direction and ink droplets are ejected by using the head unit 40 without moving the head unit 40 in a case where the head unit 40 is positioned in a position in which the direction of the nozzle array is in a direction different from the predetermined direction.

Accordingly, when the paper width is large, the head unit 40 is positioned in the first position and a print operation using the above-described serial method can be performed. On the other hand, when the paper width is small, the head unit 40 is positioned in the second position, and a print operation using the above-described line method can be performed.

What is claimed is:

1. A liquid ejecting apparatus comprising:
a head including a nozzle array in which nozzles for ejecting liquid droplets on a medium are aligned;
a transport mechanism that transports the medium in a transport direction;
a moving mechanism that moves the head in a moving direction that is a direction for intersecting the transport direction;
a position determining mechanism that can position the head in a first position in which the direction of the nozzle array is a predetermined direction with respect to the transport direction and a second position in which the direction of the nozzle array is a direction different from the predetermined direction; and
a controller that ejects liquid droplets on the medium with the head moving in the moving direction by using the moving mechanism in a case where the head is positioned in the first position, and transports the medium in the transport direction and ejects liquid droplets by using the head without moving the head in a case where the head is positioned in the second position.

2. The liquid ejecting apparatus according to claim 1, wherein the direction of the nozzle array for a case where the head is positioned in the first position is the transport direction.

3. The liquid ejecting apparatus according to claim 1, wherein the direction of the nozzle array for a case where the head is positioned in the second position is a direction for intersecting the transport direction.

4. The liquid ejecting apparatus according to claim 1, wherein the position determining mechanism rotates the head by using a part of the head as a fulcrum.

5. The liquid ejecting apparatus according to claim 1, wherein the position determining mechanism includes a first attachment part that can fixedly attach the head to the first position and a second attachment part that can fixedly attach the head to the second position.

6. The liquid ejecting apparatus according to claim 5, wherein one head is attached to the first attachment part and another head is attached to the second attachment part.

7. A method of ejecting liquid droplets, the method comprising:
ejecting liquid droplets on a medium with a head moving in a direction for intersecting a transport direction in a case where the head is positioned in a position in which the direction of a nozzle array is a predetermined direction with respect to the transport direction of the medium; and
transporting the medium in the transport direction and ejecting liquid droplets by using the head without moving the head in a case where the head is positioned in a position in which the direction of the nozzle array is a direction different from the predetermined direction.
